(19) United States
(12) Patent Application Publication
(10) Pub. No.: US 2017/0277837 A1
(43) Pub. Date: Sep. 28, 2017

(54) METHOD, SYSTEM AND APPLICATION FOR MONITORING KEY PERFORMANCE INDICATORS AND PROVIDING PUSH NOTIFICATIONS AND SURVEY STATUS ALERTS

(71) Applicant: Think Anew LLC, Flowood, MS (US)

(72) Inventor: Don Glidewell, Madison, MS (US)

(73) Assignee: Think Anew LLC, Flowood, MS (US)

(21) Appl. No.: 15/620,245

(22) Filed: Jun. 12, 2017

Related U.S. Application Data
(63) Continuation of application No. 15/201,060, filed on Jul. 1, 2016.
(60) Provisional application No. 62/188,122, filed on Jul. 2, 2015.

(51) Int. Cl. G06F 19/00; H04L 12/58; G06Q 10/06; G06Q 30/02; H04W 4/12

(52) U.S. Cl. CPC G06F 19/327; G06Q 30/0201; H04L 51/04; H04W 4/12; G06Q 10/06393

(57) ABSTRACT

A method, system and application for the real-time monitoring of key performance indicators (“KPI” or “KPIs”) and providing KPI alerts and survey status alerts to users via push notifications (e.g., text messages).

### CROSS REFERENCE TO RELATED APPLICATION

This application is a continuation of application Ser. No. 15/201,060 filed Jul. 1, 2016, which claims priority to U.S. Provisional Application Ser. No. 62/188,122, filed Jul. 2, 2015, the entirety of which is incorporated herein by reference.

### FIELD OF THE INVENTION

Embodiments disclosed herein relate to and provide a method, system and application for the real-time monitoring of key performance indicators (“KPI” or “KPIs”) and providing KPI alerts and survey status alerts to users via push notifications (e.g., text messages).

### BACKGROUND

The long term care industry has continued to be plagued with increased regulatory fines coupled with decreased reimbursement rates. Hospitals received “Meaningful Use” grants to outfit their facilities with the technology necessary to support electronic health records, while long term care facilities had sequestration reductions applied to their Medicare rates. This leaves operators of these facilities operating on the slimmest of margins.

Accordingly, there is a desire and need for these facilities to receive, monitor, react to and report key indicators impacting patient care and/or the efficiency of the services provided by the facilities.

In addition, long term care providers are subject to routine inspections (known as surveys) where deficiencies and/or other issues are reported by a state or other regulatory agency. The providers are required to fix these deficiencies/issues within a predetermined scheduled time. It is therefore desirable to ensure that facility receives the support it needs to fulfill survey requests on a timely basis and to predict and be alerted to subsequent visits.

### SUMMARY

The disclosed embodiments relate to and provide for the real-time monitoring of key performance indicators (“KPI” or “KPIs”) and providing KPI alerts and survey status alerts to users via push notifications (e.g., text messages). In addition, text based and/or graphical reports of the information monitored and analyzed by the disclosed embodiments and/or the raw data used that was monitored and analyzed may be pushed to client's, key personnel and/or other users of the disclosed method, system and application.

In one embodiment, a system and method can be implemented via a website (e.g., “ThinkAnew.com”) operated by a server accessible by the user over the Internet or other network. In another embodiment, a system and method can be implemented using an application that can be downloaded onto a mobile device (e.g., smartphone, PDA, tablet) and accessed by the user via the mobile device. The disclosed principles may be described herein or in the figures as a “Virtual Intelligence for Better Execution” (“VIBE”) program or application.

The method, system and application disclosed herein will supply operators with the proper tools and reporting necessary to e.g., monitor their census, hospital readmission rates, collection efforts and quality of care to their residents, to name a few. The disclosed embodiments also provide substantially real time data analysis and monitoring and push notifications that allow operators to make proactive decisions versus reactive decisions and make those decisions in a cost effective manner. Raw data and/or text based and/or graphical reports of the information monitored and analyzed by the disclosed embodiments may be pushed to client's, key personnel and/or other users of the disclosed method, system and application.

While the disclosed embodiments are described with reference to the health care industry (e.g., long term or senior care industries), it should be appreciated that the disclosed principles are not to be limited to any particular industry.

### BRIEF DESCRIPTION OF THE DRAWINGS

FIG. 1 illustrates an example system for operating an embodiment disclosed herein.

FIG. 2 illustrates an example home or login page when the disclosed embodiments are implemented via a website.

FIG. 3 illustrates an example web page for the executive tab disclosed herein.

FIG. 4 illustrates an example web page for setting up which personnel gets alerts and by what notification method.

FIG. 5 illustrates an example web page for setting pushed messages in accordance with the disclosed principles.

FIG. 6 illustrates an example web page for the census tab disclosed herein.

FIG. 7 illustrates an example web page for the labor tab disclosed herein.

FIG. 8 illustrates an example web page for the AR tab disclosed herein.

FIG. 9 illustrates an example web page for the clinical tab disclosed herein.

FIG. 10 illustrates an example home/login screen displayed on a user's mobile device when using the application disclosed herein.

FIG. 11 illustrates an example executive tab screen displayed on a user's mobile device when using the application disclosed herein.

FIG. 12 illustrates an example census tab screen displayed on a user's mobile device when using the application disclosed herein.

FIG. 13 illustrates an example labor tab screen displayed on a user's mobile device when using the application disclosed herein.

FIG. 14 illustrates an example AR tab screen displayed on a user's mobile device when using the application disclosed herein.

FIG. 15 illustrates an example clinical tab screen displayed on a user's mobile device when using the application disclosed herein.

FIG. 16 illustrates an example admin tab screen displayed on a user's mobile device when using the application disclosed herein.

### DETAILED DESCRIPTION

As will be appreciated, the disclosed embodiments are more than a reporting repository; instead, they provide an interactive business intelligence tool. It is desirable to have users at all levels of an organization use the disclosed reports and tools to enhance their workflow. The disclosed embodiments can provide alerts to pre-defined individuals when KPIs fall outside of their accepted thresholds. This can be accomplished without the pre-defined individuals being logged into the disclosed system. It should be appreciated that throughout this disclosure references to thresholds, good thresholds or acceptable thresholds could be thresholds set by the user, the system or a governing body and that what is a good/acceptable threshold should not limit the disclosed principles. In addition, the raw data and/or text based and/or graphical reports of the information monitored and analyzed by the disclosed embodiments may be pushed to client's, key personnel and/or other users of the disclosed method, system and application.

According to the disclosed principles, key performance indicators will measure benchmarks for e.g., census, labor, accounts receivable (“AR”) and clinical measures functions. Reports may be displayed in a graphical format so that performance is easy to ingest upon first glance. Moreover, each graph can be exported to multiple formats to that details can be analyzed offline or by another application, if desired.

The disclosed embodiments provide a “Survey Alerting” feature that will allow a facility to alert pre-defined personnel (e.g., internal and regional staff) when e.g., a state survey teams enters a facility. This is a separate feature than the alerts/push notifications generated based on KPIs. The Survey Alerting feature (also described and/or illustrated herein as a “survey status alert”) not only allows for the facility to receive the support it may need in order to fulfill the current survey requests on a timely basis, but will also record the visit's activity and allow the disclosed embodiments to build in predictability reporting for subsequent visits. Survey results will also be loaded into the disclosed embodiments, allowing real-time alerts to be triggered to e.g., the staff or managers; these alerts may report prior deficiencies and will be generated during an impending survey window (i.e., the window in which the next survey may occur).

The disclosed embodiments may allow for the LTC TrendTracker template to be pre-populated so that user can easily upload to TrendTracker for regional and national MDS/RUG reporting analysis. It is known that LTC Trend Tracker is a web based tool that is available free of charge with an ACHA membership. The LTC Trend Tracker tool allows users to benchmark quality measures against their peers. Moreover, and as discussed below, the disclosed embodiments will pull-in information and data from multiple sources and databases.

For example, for pre-existing cloud-based managed healthcare systems (e.g., PointClickCare, American HealthTech) customers, data will be sent from the healthcare systems to a secured ftp server via log files and the disclosed embodiments will pick up these log files and apply the data to a client specific data relay database hosted by the disclosed system. Once the log files are applied to the data relay, the disclosed embodiments will pull appropriate data elements out of the data relay and into the system's database (according to the timing from log files to data relay as well as the client's specific schedule). A refresh date/time will displayed to the user so that the user will know the last time the data displayed was last refreshed. In addition to, or alternatively, the disclosed embodiments can host the database for the healthcare system and pull information from this hosted database. The disclosed embodiments will use scheduled data feeds that may be established by the system or its users to offload download times. Moreover, for time and attendance functions, there can be a schedule and data feed established by the user and a time and attendance vendor, if desired. For payroll purposes, there can be a schedule and data feed from a payroll vendor, if desired.

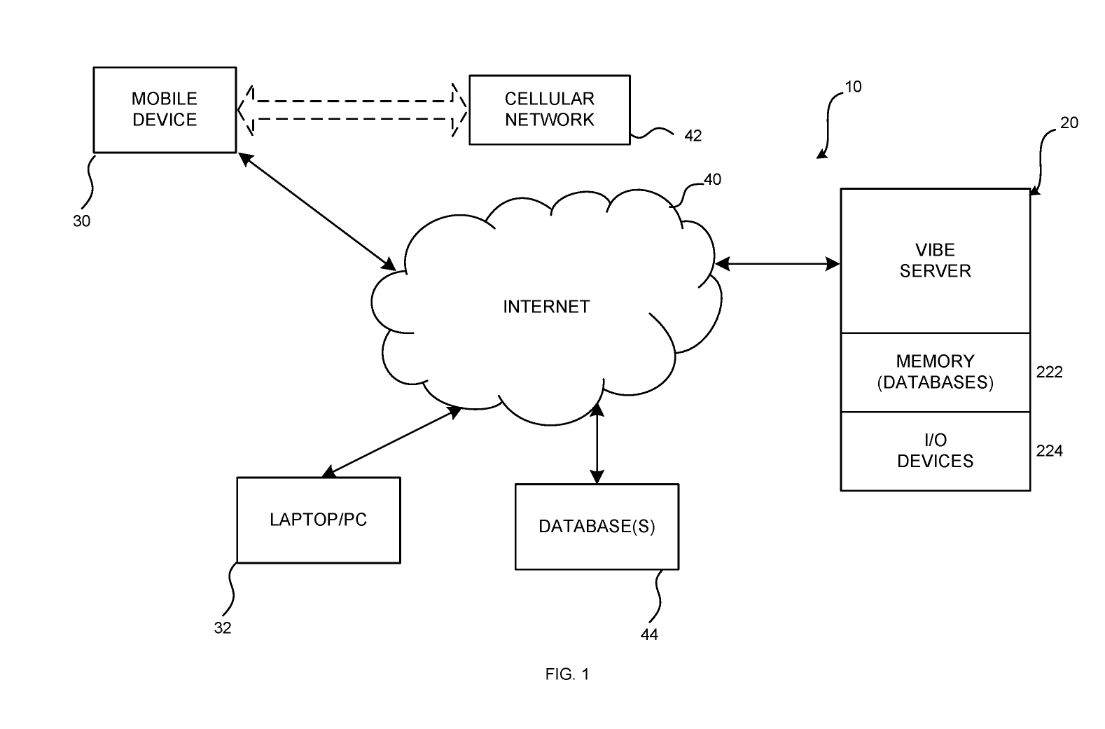

In one embodiment, the disclosed system is implemented in software (i.e., computer instructions) that are stored in a computer readable memory and executed by a processor. FIG. 1 illustrates an example system 10 comprising a server 20 (also referred to herein as a system server or VIBE server) for operating an embodiment of the method and application disclosed herein. The server 20 includes or is connected to a memory 22 for storing computer instructions required to implement the method described herein and to store the various databases, user information and algorithms used during the processes described herein. The server 20 can be accessed over a wired or wireless network 40 (shown as the Internet in this example). User devices include a mobile device 30 and a laptop/PC 32 that connect to the server 20 via the network 40. The server 20 can include or be connected to input/output devices 24 such as displays, scanners, printers, etc. Various databases 44 required for the disclosed processing may also be connected to the server 20 via the network 40. In addition, one or more user devices can get access to the server 20 via a cellular connection 42, if desired.

In one embodiment, the disclosed system and method can be implemented using an application program (e.g., the VIBE application) that can be downloaded onto a mobile device 30 (e.g., smartphone, PDA, tablet) and accessed by a user via the mobile device 30. The application program will cause the mobile device 30 to interact with the system server 20 to perform certain features of the method disclosed herein. In another embodiment, the disclosed system and method can be implemented via a website (e.g., “ThinkAnew.com” or “VIBE.com”) operated by a server accessible by a user device (e.g., smartphone, PDA, tablet, laptop, personal computer, etc.) or online application over the Internet or other network.

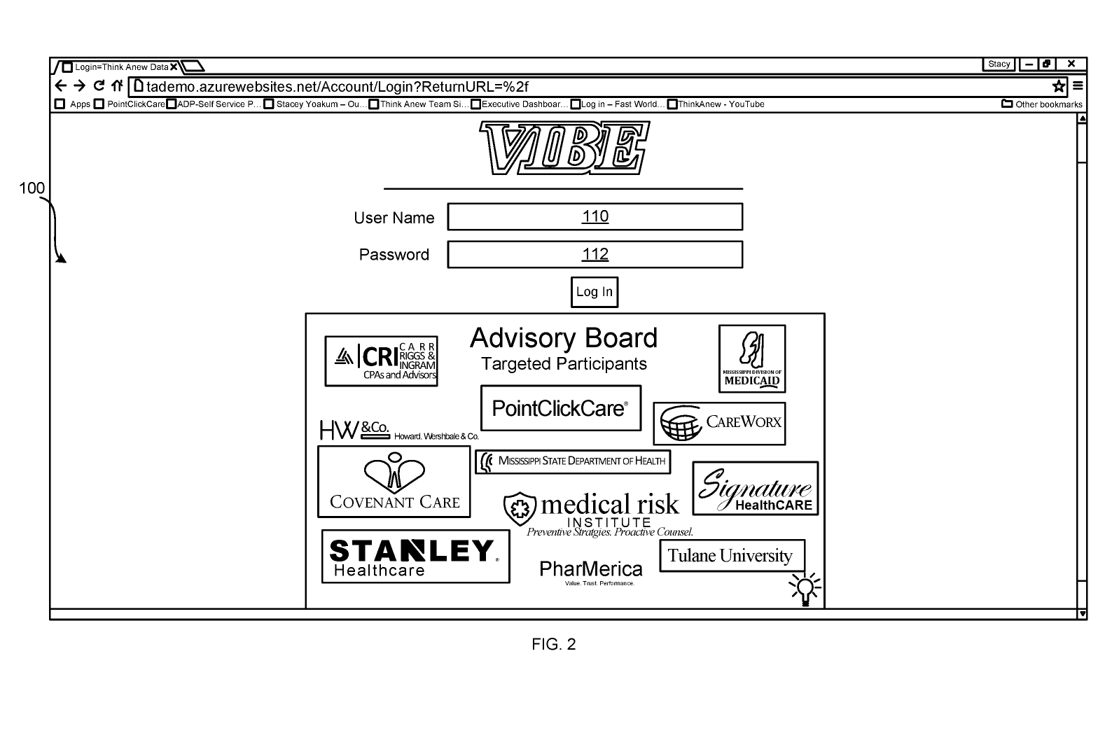

FIG. 2 illustrates an example home or login page 100 when the disclosed embodiments are implemented via a website. Users of the disclosed embodiments will require a username 110 and password 112, along with other user information that can be stored in the system's memory or databases. Stored user information may include defined access level or rights to or within the VIBE system 10 based on their role, the organization and facility name, and login history.

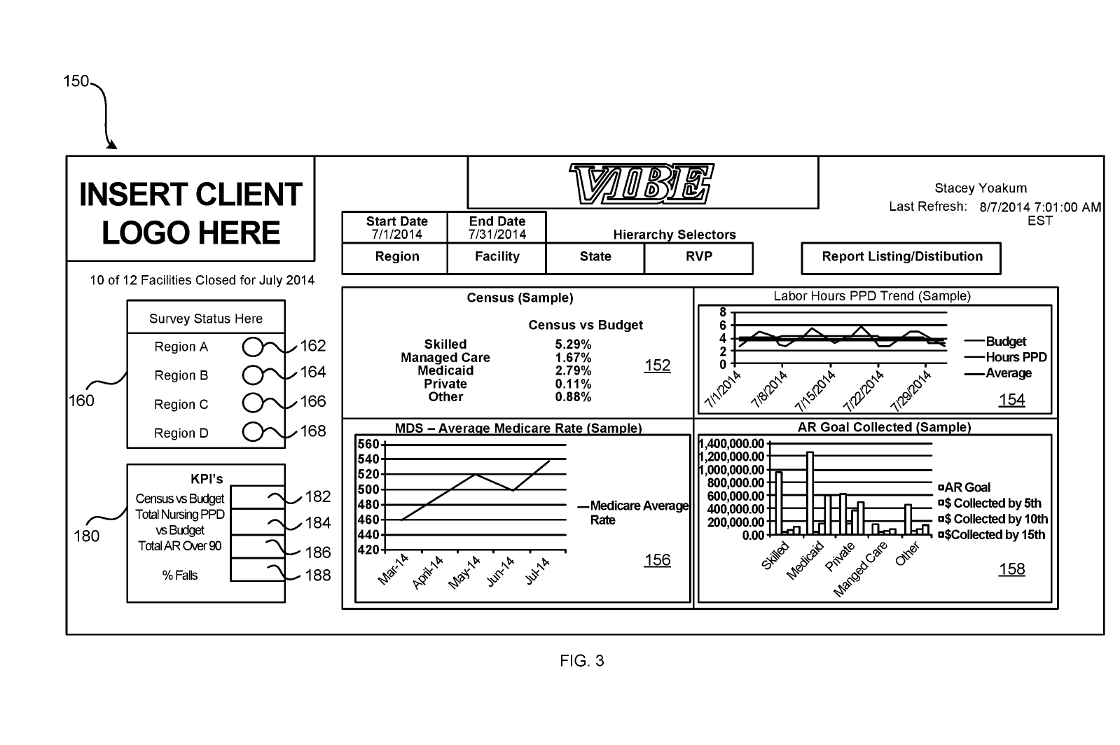

Once logged in, the user can access several different tabs depending upon the functionality/reporting desired. The selected tab brings up a corresponding web page. For example, FIG. 3 illustrates an example web page 150 for the executive tab disclosed herein. The illustrated page 150 provides graphical and textual illustrations of reports for census versus budget 152, labor hours PPD trend 154, MDS average Medicare rate 156, and AR goal collected 158 information. This information can be presented in both graphical and textual form. The example page 150 also illustrates a unique survey status portion 160 and KPI's portion 180. As will all of the example pages and screens discussed herein, the web page 150 may include other useful indicia such as e.g., start date, end date, region, facility, state and RVP. The functionality provided by the illustrated reports of page 150 are now described.

For the census versus budget report 152, the disclosed embodiments will categorize skilled population based on client preference, and report a census of “Skilled vs Budget” as a variance percentage—all other payers are reported as “Other vs Budget” also as a variance percentage. Report details will include values in addition to percentages. As can be appreciated, this report 152 enables the real time monitoring of census numbers versus budgeted numbers with skilled mix segregated.

For the labor hours PPD (Per Patient Day) trend report 154, the disclosed embodiments will pull labor hours in PPD format for all job codes selected by the client, and report those hours against budgeted PPD as well as a rolling average. As can be appreciated, this report provides real time monitoring of labor hours to better manage labor costs, and for comparison vs budget. Nursing PPD regulations are mandated under the Nursing Home Federal Requirements, F353 §483.30 Nursing Services. The facility must have sufficient nursing staff to provide nursing and related services to attain or maintain the highest practicable physical, mental, and psychosocial well-being of each resident, as determined by resident assessments and individual plans of care. The intent of §483.30 (and the disclosed embodiments) is to assure that sufficient qualified nursing staff are available on a daily basis to meet residents' needs for nursing care in a manner and in an environment which promotes each resident's physical, mental and psychosocial well-being, thus enhancing their quality of life.

For the MDS (Minimum Data Set—part of the U.S. federally mandated process for clinical assessment of all residents in Medicare or Medicaid certified nursing homes) average Medicare rate report 156, the disclosed embodiments will provide the trending of the average Medicare rate, based on MDS ARD dates within a selected time period. ARD is defined as the specific end point of look-back periods in the MDS assessment process. It allows for those who complete the MDS to refer to the same period of time when reporting the condition of the resident. For SNF PPS assessments, this date also determines payment. As can be appreciated, this report provides financial forecasting for the Medicare population.

For the AR goal collected report 158, the disclosed embodiments will calculate the goal for Medicaid and Medicaid pending as: prior month revenue +/− prior month adjustments/days in the month to get a daily rate. The daily rate is then multiplied by the days in the state's billing schedule to obtain the goal amount. For all other payers, the calculation will include the prior month's revenue +/− prior month adjustments. This report will pull the percentage of the cash goal collected by e.g., the 5^{th}-10^{th} and 15^{th} day of the current month. As can be appreciated, this report measures collections activity to determine the amount of funds in AR that gets calculated based against the goals of the company.

A key and unique feature of the disclosed embodiment is the survey status alert feature 160. This utility will reside on the dashboard and allows a staff member or other user to trigger an alert both internally and to e.g., a corporate/regional team when state surveyors enter the building by selecting one of the illustrated indicators 162, 164, 166, 168. The indicators 162, 166, 168 are shown in their unselected state while indicator 164 is shown in a selected state. In the illustrated example, each indicator 162, 164, 166, 168 is associated with a particular region (although they are not to be limited to regions). This survey status alert feature does not currently exist today. In use, the date and time of the visit will be captured and predictability reporting will be available based on visit history. Because the disclosed embodiments record results of the surveys, information from the last survey may be used to alert the staff of prior survey deficiencies as soon as the site enters the survey window (e.g., before a visit so that past deficiencies can be corrected before the next visit).

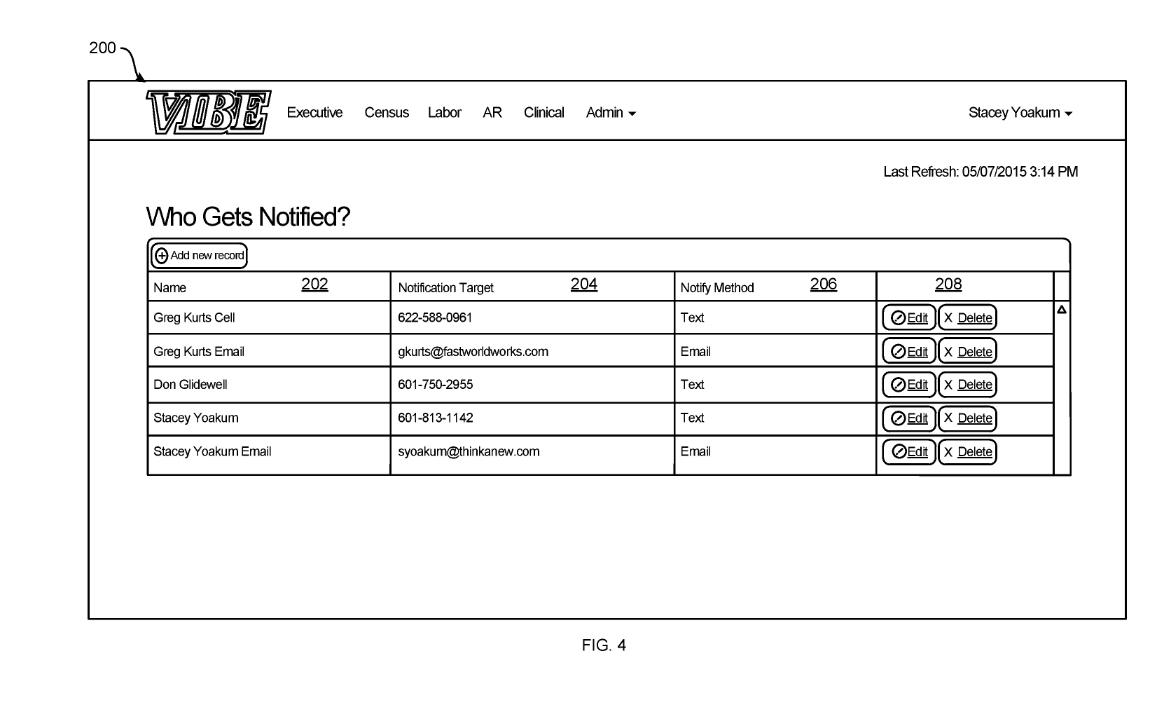

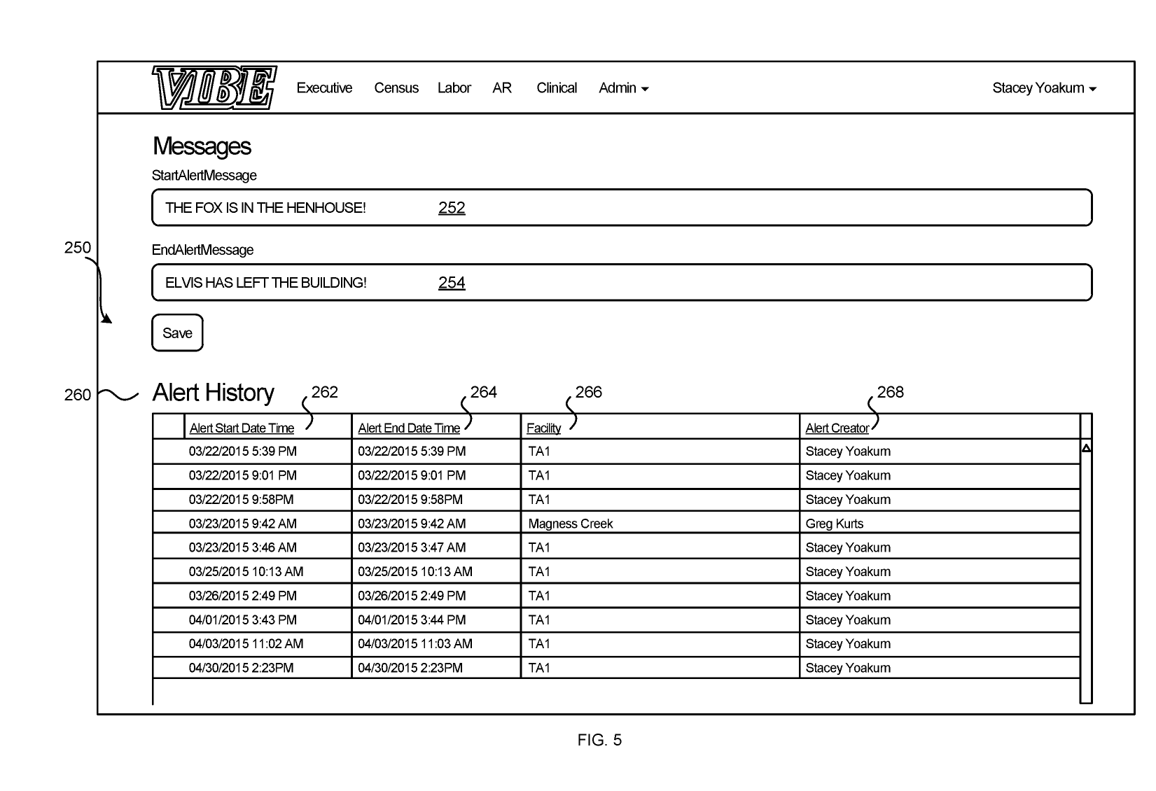

FIG. 4 illustrates an example page 200 for setting up which personnel gets the alert and by what notification method (e.g., text, email, etc.). That is, there is a field 202 for entering the names of the people to receive survey status alerts; a field 204 for a phone number or email address the alert will be sent to; a field 206 for identifying how the alert will be transmitted (e.g., text, email, etc.); and fields 208 for editing or deleting the entries on this page 200. FIG. 5 illustrates an example page 250 for entering a message 252 for when the visit begins (i.e., StartAlertMessage) and a message 254 for when the visit is complete (i.e., EndAlertMessage). The example page 250 also displays alert history 260 comprising an alert start date time field 262, alert stop date time field 264, a facility field 266 and an alert creator field 268.

The disclosed features also provide the user with the ability to distribute reports, graphs directly from the dashboard. That is, there is no need to save them locally before sending them. A month end close indicator (not shown) can also be used to monitor close progression during month end period. The disclosed principles provide the user with the ability to customize from and thru dates. Any hierarchy can be defined using typical known selectors, as desired.

Another key and unique feature of the disclosed embodiment is the KPI alerts feature 180. FIG. 3 illustrates some KPIs 182, 184, 186, 188 that could be implemented on the page 150 for the executive tab. According to the disclosed principles, alerts will be pushed to assigned individuals when KPIs fall outside of acceptable threshold values. These thresholds are also displayed in the page 150 in the KPI portion 180 so that they can be viewed by a user. Depending on the KPI, alters can be generated at different times. For example, for the “census vs budget” KPI 182, alerts can be generated when the census numbers fall short of the budgeted numbers. As with all KPIs, the thresholds can be set by the system or the user. For the “Total Nursing PPD vs Budget” KPI 184, alerts can be generated when nursing PPD numbers are outside of good threshold values. For “Total AR over 90” KPI 186, alerts can be generated when the total AR percentage over 90 days is above the acceptable threshold. For “% Falls” KPI 188, alerts can be generated when the percentage of falls is above the acceptable threshold.

It should be appreciated that reports can also be pushed out to the users and/or clients of the facility in more than one manner. For example, the reports mentioned above and below can be pushed via email, text message, posted to an FTP site, or SharePoint directly to the client or other interested party. The pushed reports can be graphical and/or textual in nature, can be images of what is displayed on one or more of the example pages described herein, and/or can contain the raw data that was used to monitor the KPIs and/or generate any of the reported information disclosed herein. The reports may pushed periodically, aperiodically or upon request, as desired based on system and/or user preferences.

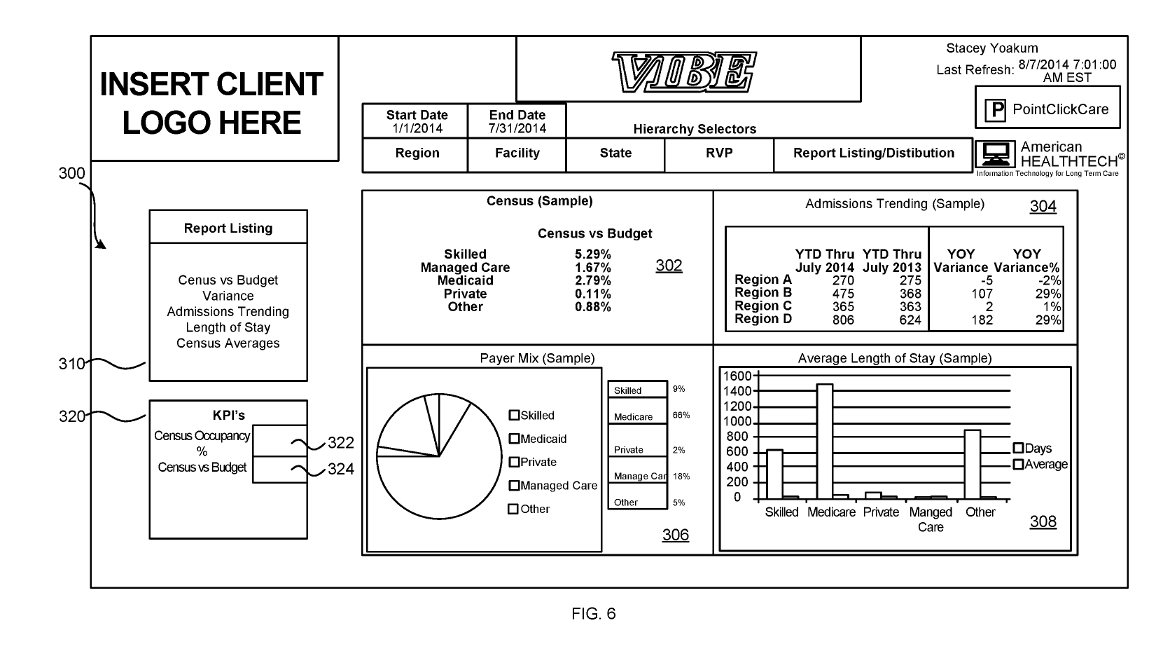

FIG. 6 illustrates an example web page 300 used for the census tab. The illustrated page 300 provides graphical and textual illustrations of reports for census versus budget 302, admissions trending 304, payer mix 306, and average length of stay 308 information. This information can be presented in both graphical and textual form. The example page 300 also illustrates a report listing 310 (summarizing the reports available) and a unique KPI's portion 320 (listing the available KPIs for this page). The functionality provided by the illustrated reports 302, 304, 306, 308 are now described.

The census versus budget report 302 may be the same as discussed above with respect to the executive tab. For the admissions trending report 304, the disclosed embodiments will perform Year over Year (“YOY”) Admissions trending. This will report the number of admissions by month, by source, and then as a percentage of YOY variance. As can be appreciated, this report provides a snapshot view of overall admissions as well as admission sources so marketing efforts can be allocated appropriately.

For the payer mix report 306, the disclosed embodiments will categorize skilled population based on client preference, and will include all other primary payers as a percentage of overall census population. As can be appreciated, this report can be used as a predictor of reimbursement expectations. For average length of stay 308, the disclosed embodiments will calculate the average length of stay as total inpatient days/discharges for time period selected. The illustrated graph may include total days in relation to average. As can be appreciated, this report allows for better management of resources and increases efficiency of patient care.

The page 300 for the census tab may also provide the additional functionality discussed above (e.g., distributing reports, customizable from/thru dates and hierarchy). In addition, it will provide access to payroll software solutions like ADP. Moreover, the page 300 for the census tab includes the KPI feature 320 (i.e., providing alerts when the KPI is beyond an acceptable threshold). For the illustrated embodiment, there is a “Census Occupancy %” KPI 322, which is calculated as inpatient days/available beds*100 (for a percentage display). Alerts will be generated when the occupancy percentage falls short of acceptable threshold amounts. For the “Census vs Budget” KPI 324, alerts are generated when the census totals fall short of budgeted numbers.

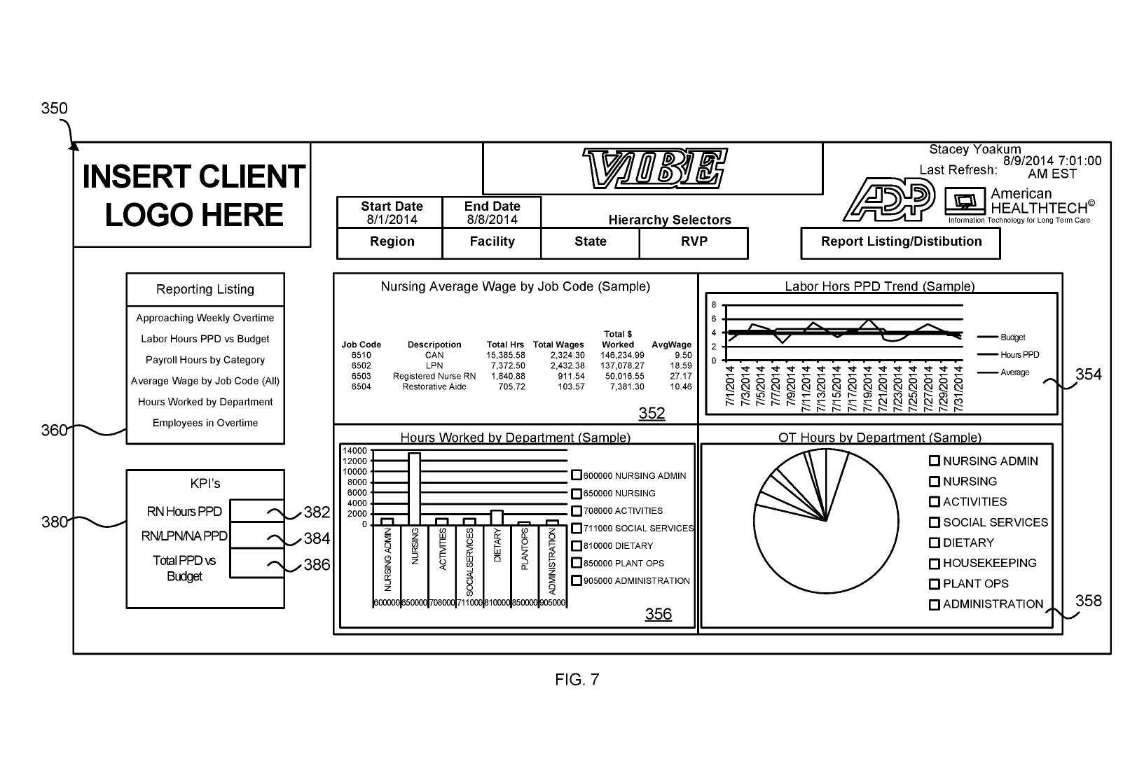

FIG. 7 illustrates an example web page 350 for the labor tab. The illustrated page 350 provides graphical and textual illustrations of reports for nursing average wage by job code 352, labor hours PPD 354, hours worked by department 356, and OT (overtime) hours by department 358. This information can be presented in both graphical and textual form. The example page 350 also illustrates a report listing 360 and a unique KPI's portion 380. The functionality provided by the illustrated reports are now described.

For the nursing average wage by job code report 352, the disclosed embodiments will determine total hours−total wages−total dollars worked and calculates the average wage as a total dollar amount worked/total hours. As can be appreciated, this report allows the user to manage labor hours.

For the labor hours PPD report 354, the disclosed embodiments will pull labor hours in PPD format for all job codes selected by client, and report those hours against budgeted PPD as well as a rolling average. As can be appreciated, this report provides real time monitoring of labor hours to better manage labor costs, and for comparison versus budget.

For the hours worked by department report 356, the disclosed embodiments will report the total hours worked by department for a selected period. As can be appreciated, this report allows the user to identify staffing needs and labor management opportunities by department. For the OT hours by department report 358, the disclosed embodiments reports the hours classified as Overtime (as defined by client), categorized by department for period selected. As can be appreciated, this report provides overtime hours identification and management.

As shown in the report listing 360, additional labor reporting may include an “Approaching Weekly Overtime” report to identify staff who are approaching overtime hours for a selected period, providing an opportunity to reallocate staff to save overtime dollars. An “Employees in Overtime” report can identify staff who have overtime hours for a selected period, providing an opportunity to reallocate staff to save overtime dollars.

The page 350 for the labor tab may also provide the additional functionality discussed above (e.g., distributing reports, customizable from/thru dates and hierarchy). In addition, it may provide the user access to AR and Payroll software. The labor tab will also include the KPIs feature 380 (i.e., pushing alerts to select individuals when the KPI is beyond an acceptable threshold). For the illustrated embodiment, there is an “RN Hours PPD” KPI 382 that will push an alert when hours coded to an RN job code fall outside good/acceptable threshold values. This may also comport to the Nursing Home Compare Five-Star Rating Staffing Measure. The “RN/LPN/NA PPD” KPI 384 will generate an alert with hours coded to RN, LPN and NA job codes if they fall outside good/acceptable threshold values. This may also comport to the Nursing Home Compare Five-Star Rating Staffing Measure. The “Total PPD vs Budget” KPI 386 will generate an alert when the PPD for all job codes falls outside of good/acceptable threshold values.

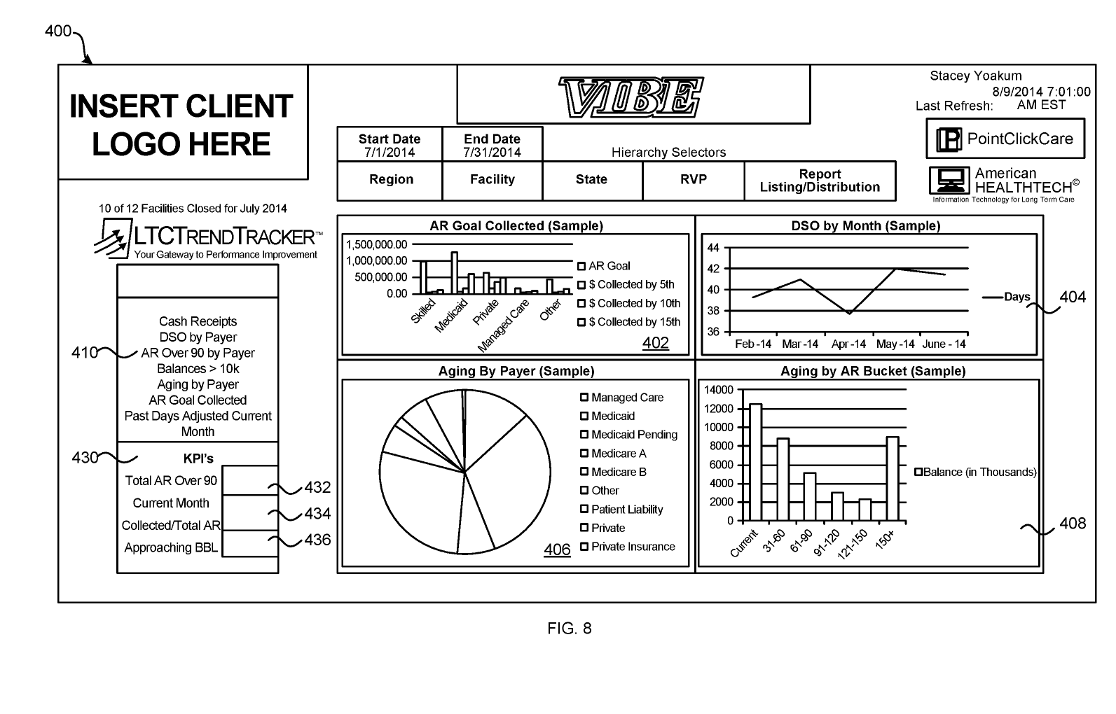

FIG. 8 illustrates an example web page 400 for the AR tab. The illustrated page 400 provides graphical and textual illustrations of reports for AR goal collected 402, DSO (Days Sales Outstanding) 404, which is a calculation used by a company to estimate their average collection period) by month, aging by payer 406, and aging AR bucket 408 reports/information. This information can be presented in both graphical and textual form. The example page 400 also illustrates a report listing 410 and a unique KPI's portion 430. The functionality provided by the illustrated reports are now described.

For the AR goal collected report 402, the disclosed embodiments calculate the goal for Medicaid and Medicaid pending as follows: Prior month revenue +/− Prior Month Adjustments/days in Month to get a daily Rate. The daily rate is then multiplied by the days in the State's billing schedule for the goal amount. For other payers, the goal is Prior month revenue +/− Prior Month Adjustments. As can be appreciated, this report allows the user to measure collections activity to determine the amount of funds in A/R that gets calculated based against the goals of the company.

For the DSO by month report 404, the disclosed embodiments determine the Net AR for a selected time period/Revenue Per Day (Revenue/Days in selected time period). As can be appreciated, this report illustrates the average amount of time it takes from when a dollar of revenue is received until it is put into the facility's pocket.

For the aging by payer report 406, the disclosed embodiments present graphical representations of total aging balances by payer (in percentages). As can be appreciated, this report assists with collection efforts by identifying payers that have the largest balances due. For the aging AR bucket report 408, the disclosed embodiments provide the total aging balances assigned by period (bucket), including payer/resident details. As can be appreciated, this report assists in identifying and collecting older balances.

The page 400 for the AR tab will also provide additional functionality such as e.g., reporting cash receipt entries for time period selected by user; reporting all residents that have a balance over $10,000 to identify and allow for appropriate AR decision making; and reporting past period days (with GL Period included) during the current GL month. The additional functionality discussed above (e.g., distributing reports, customizable from/thru date and hierarchy) may be provided. Moreover, the user can have access to the AR software and a month end close indicator. In addition, an auto-populated, exportable TrendTracker RUG data template that can be uploaded into LTC TrendTracker may be provided.

The page 400 for the AR tab will also include a report listing 410 and the KPIs feature 430 (i.e., pushing alerts to select individuals when the KPI is beyond an acceptable threshold). For the “Total AR over 90” KPI 432, alerts will be pushed when the Total AR percentage over 90 days is above an acceptable threshold. For the “Current Month Collected % of Total AR” KPI 434, alerts will be pushed when the percentage collected falls short of acceptable threshold. For the “Approaching BBL” KPI 436, alerts will be pushed/generated when claim counts approaching “Beyond Bill Limits” are higher than an acceptable threshold.

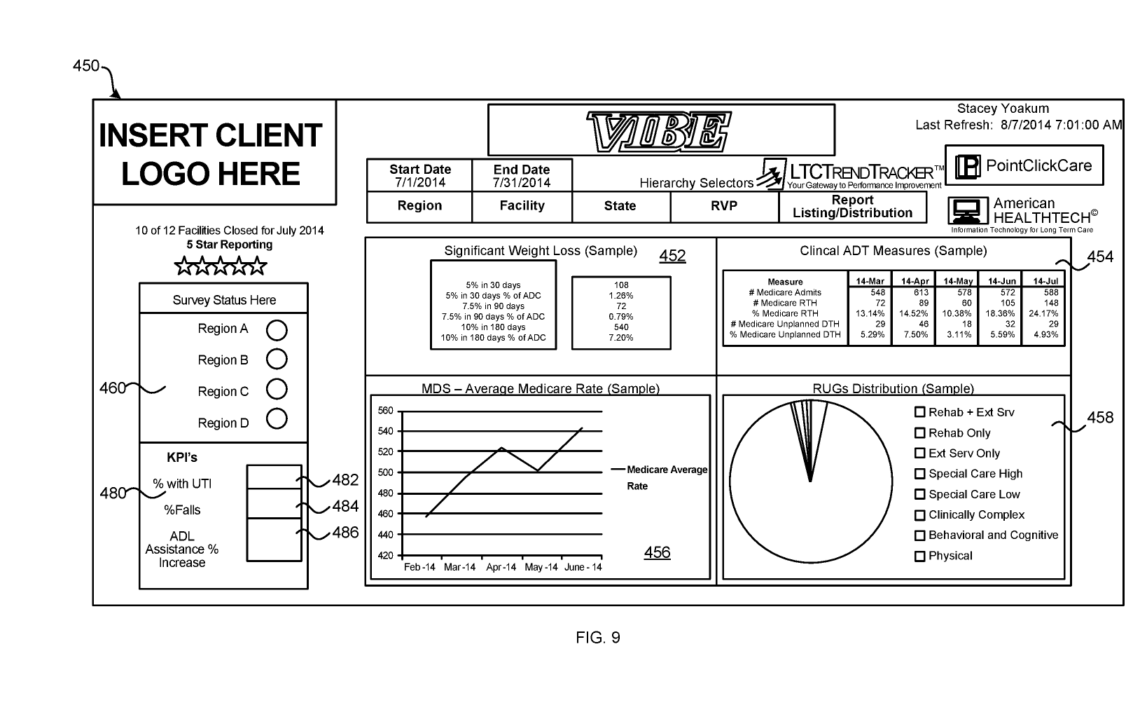

FIG. 9 illustrates an example page 450 for the clinical tab. The illustrated page 450 provides graphical and textual illustrations of reports for significant weight loss 452, clinical ADT measures 454, MDS−average Medicare rate 456 and RUGs distribution 458 reports/information. This information can be presented in both graphical and textual form. The example page 450 also illustrates the survey status alert feature 460 (similar to the survey status alert feature 160 discussed above) and a unique KPI's portion 480. The functionality provided by the illustrated reports are now described.

For the significant weight loss report 452, the disclosed embodiments provide 30-90-180 day look back of 5%, 7.5% and 10% of resident weight loss. This includes resident count and count as a percentage of ADC. As can be appreciated, this report provides optimal dietary & clinical care by preventing unhealthy weight loss. For the clinical ADT measures report 454, the disclosed embodiments provide the trending of the number of Medicare admissions (i.e., the number of Medicare RTH (Return to Hospital) to the percentage of Medicare RTH; and the number of Medicare Unplanned DTH (Discharge to Hospital) to the percentage of Medicare Unplanned DTH). In 2014, for example, potential fines for hospitals with high readmission rates are up to 3% of Medicare bills. As can be appreciated, this report identifies return to hospital ratios and will assist in care planning with hospitals, improving resident care by reducing transfers, and enhancing hospital relationships.

For the MDS−average Medicare rate report 456, the disclosed embodiments report the trending of the average Medicare rate, based on MDS ARD dates within a selected time period. This provides for financial forecasting for the Medicare population. For the RUGs distribution report 458, the disclosed embodiments provide the distribution of Medicare resident days in each RUG-IV group for selected time period. As can be appreciated, this report provides financial forecasting for the Medicare population and staffing projections.

Other functionality may be provided by the clinical tab. For example, the survey status alert feature discussed above may be provided as shown in FIG. 9. Other functions include: the Auto-populated, exportable TrendTracker RUG data template for uploading into LTC TrendTracker; month end close indicator; access to annual 5 Star Reporting; distributing reports, graphs directly from the dashboard; user customizable From and Thru dates; hierarchy selectors defined by client; and that user having access to clinical software.

The page 450 for the clinical tab will also include the KPIs feature 480 (i.e., pushing alerts to select individuals when the KPI is beyond an acceptable threshold). For the “% with UTI” KPI 482, alerts are generated when the percentage of residents who have had a urinary tract infection within the past 30 days falls short of an acceptable threshold. A set of quality measures (QMs) has been developed from Minimum Data Set (MDS)-based indicators to describe the quality of care provided in nursing homes. These measures address a broad range of functioning and health status in multiple care area. One of these measures is the percentage of residents with a urinary tract infection. For the “% Falls” KPI 484, alerts are generated when the percentage of residents who have experienced one or more falls with major injury reported in the target period that falls below an acceptable threshold. A set of quality measures (QMs) has been developed from Minimum Data Set (MDS)-based indicators to describe the quality of care provided in nursing homes. These measures address a broad range of functioning and health status in multiple care area. One of these measures is the percentage of residents experiencing one or more falls with major injury. For the “ADL Assistance % Increase” KPI 486, alerts are generate when the percentage of residents whose need for help with ADL (Activities of Daily Living) has increased in comparison to prior assessment. A set of quality measures (QMs) has been developed from Minimum Data Set (MDS)-based indicators to describe the quality of care provided in nursing homes. These measures address a broad range of functioning and health status in multiple care area. One of these measures is the percentage of residents whose need for help with activities of daily living has increased.

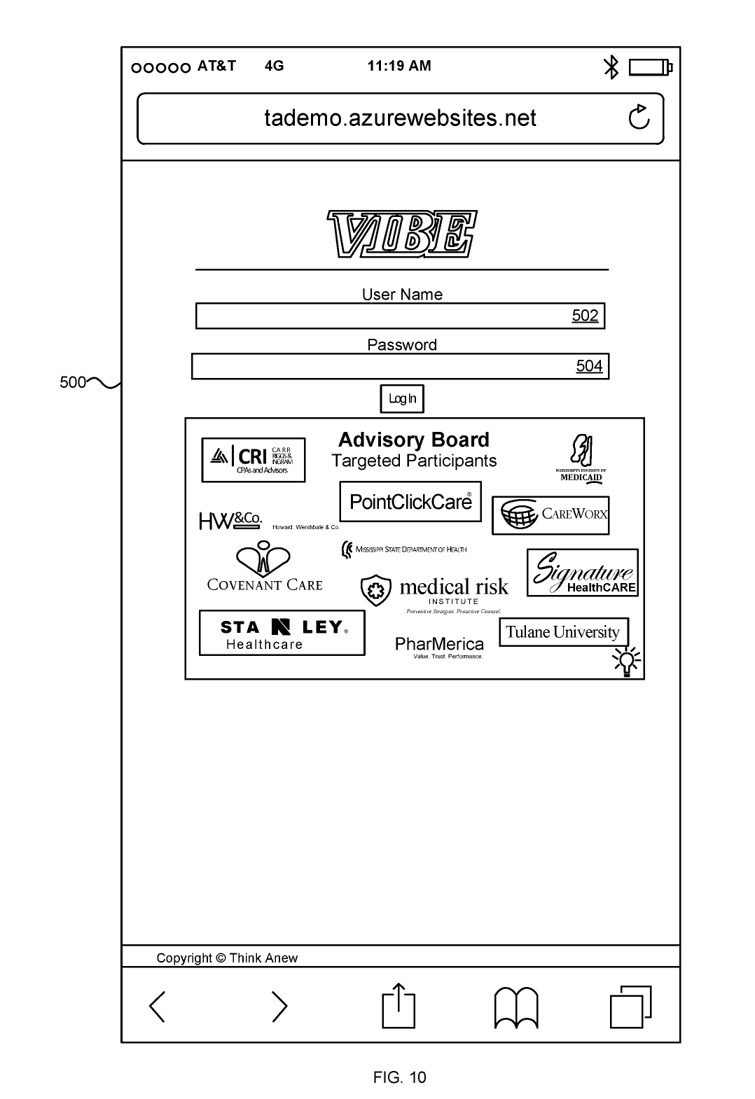

FIGS. 10-16 illustrate sample application pages/screens displayed on a user's mobile or other device when using the VIBE application disclosed herein. It should be appreciated that the functionality of the screens for the mobile device are substantially the same as the functionality discussed above for the respective website page and tabs.

FIG. 10 illustrates an example home/login screen 500 allowing the user to login to the system with a username 502 and password 504 as discussed above with respect to FIG. 2.

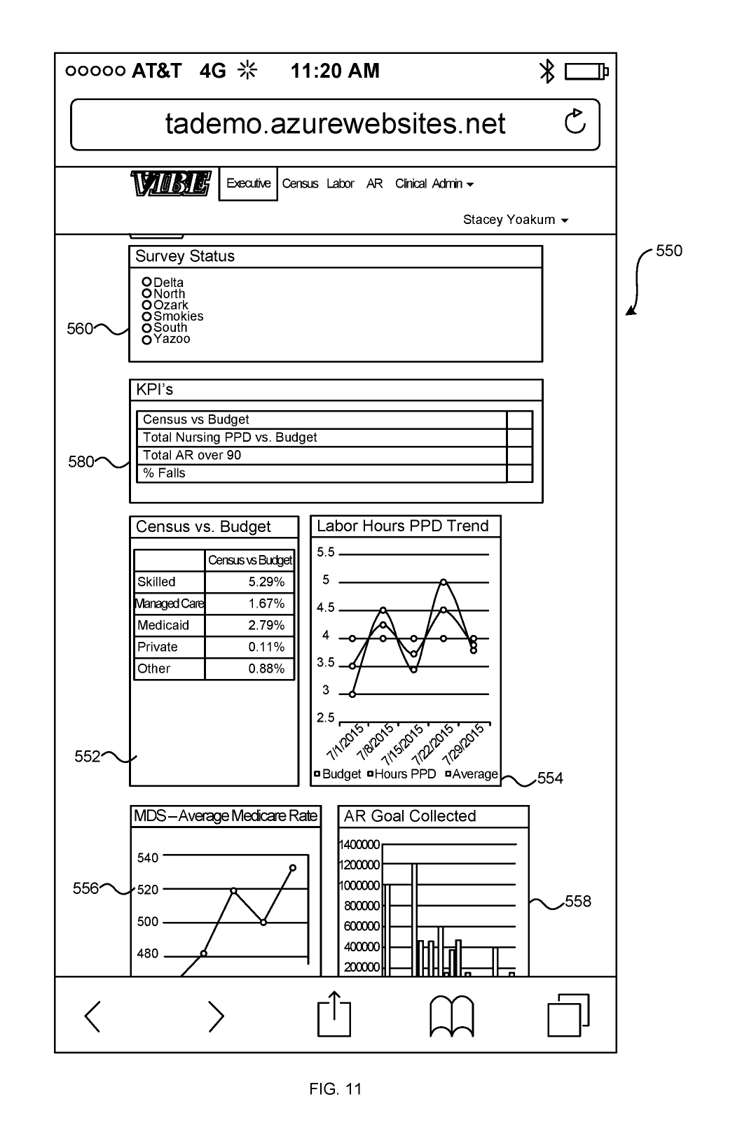

FIG. 11 illustrates an example screen 550 for the executive tab. Like the web page 150 discussed above, screen 550 includes graphical and textual illustrations of reports for census versus budget 552, labor hours PPD trend 554, MDS average Medicare rate 556, and AR goal collected 558 information. The screen 150 also includes a unique survey status portion 560 and KPI's portion 580. These functions and reports are the same as the ones discussed above for page 150.

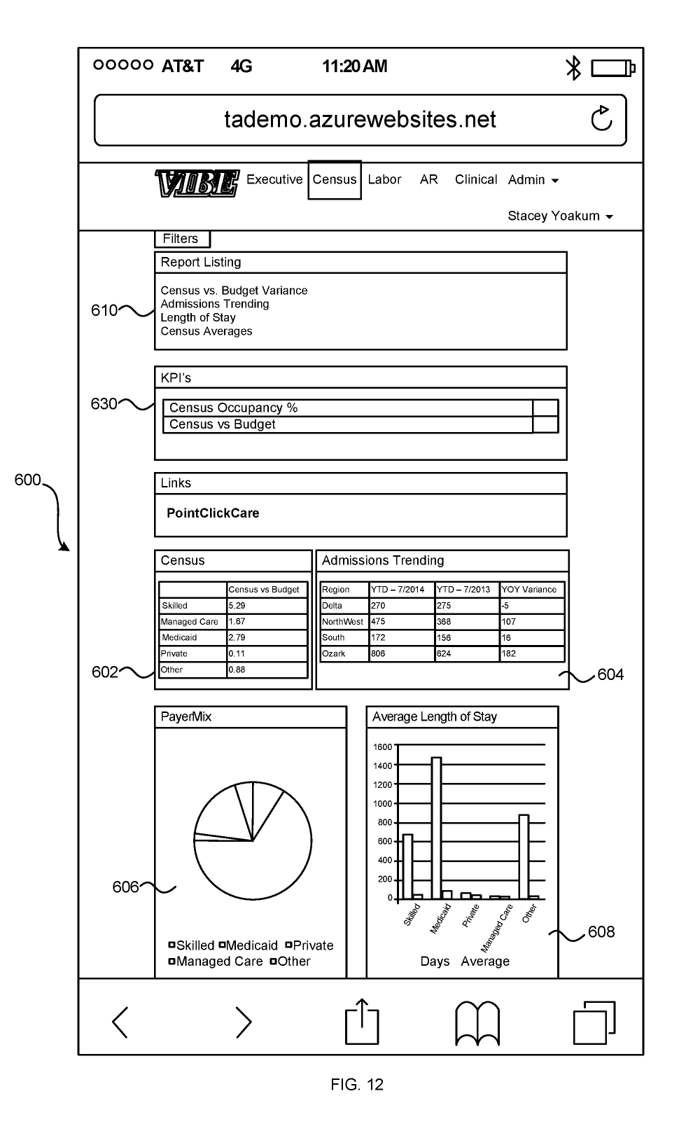

FIG. 12 illustrates an example screen 600 for the census tab. Like screen 300 discussed above, screen 600 includes graphical and textual illustrations of reports for census versus budget 602, admissions trending 604, payer mix 606, and average length of stay 608 information. The example screen 600 also illustrates a report listing 610 (summarizing the reports available) and a unique KPI's portion 630 (listing the available KPIs for this screen). These functions and reports are the same as the ones discussed above for page 300.

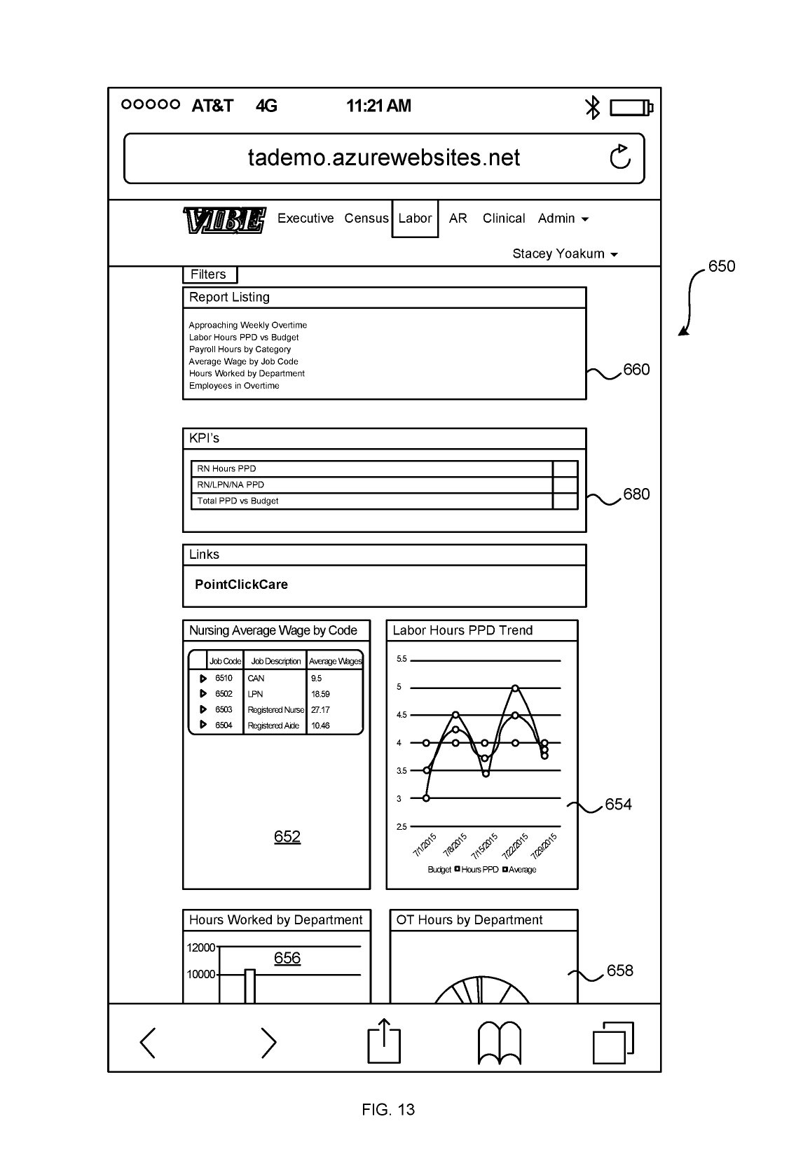

FIG. 13 illustrates an example screen 650 for the labor tab. Like screen 350 discussed above, screen 650 includes graphical and textual illustrations of reports for nursing average wage by job code 352, labor hours PPD 354, hours worked by department 356, and OT (overtime) hours by department 358. The example screen 650 also illustrates a report listing 660 (summarizing the reports available) and a unique KPI's portion 680 (listing the available KPIs for this screen). These functions and reports are the same as the ones discussed above for page 350.

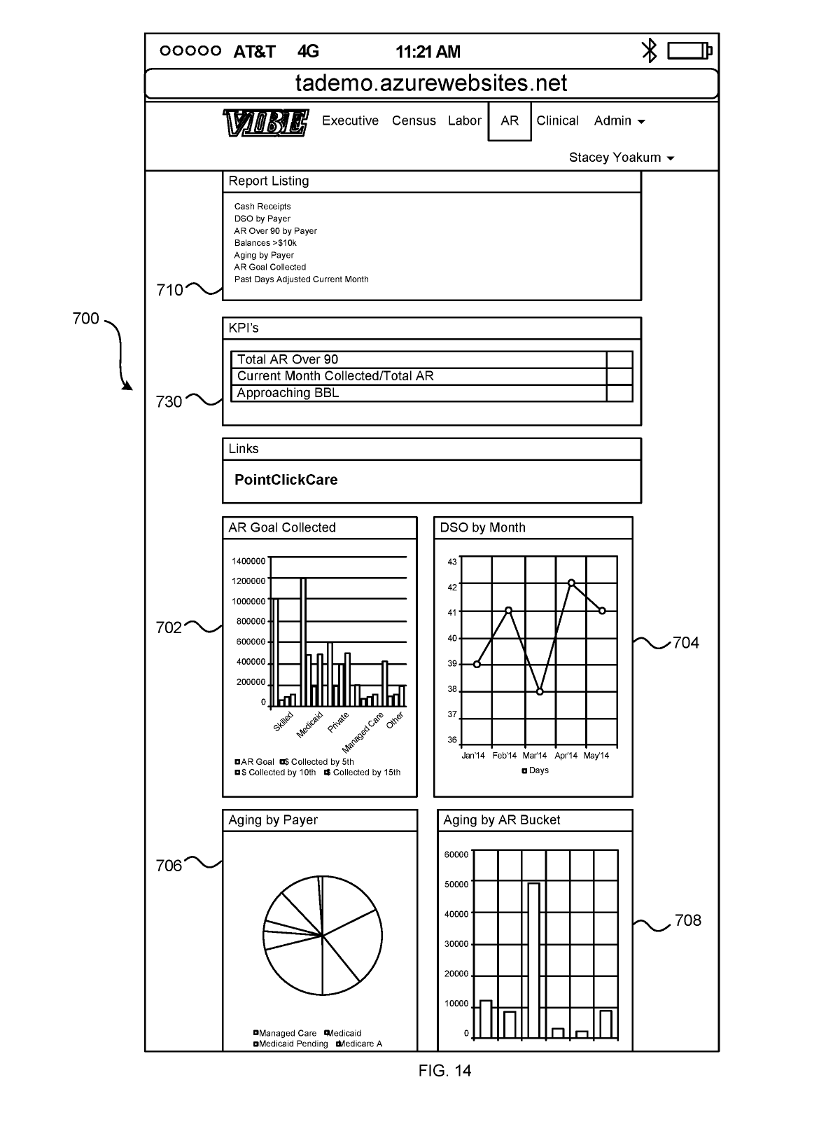

FIG. 14 illustrates an example screen 700 for the AR tab. Like screen 400 discussed above, screen 700 includes graphical and textual illustrations of reports for AR goal collected 702, DSO (Days Sales Outstanding) 604, aging by payer 706, and aging AR bucket 708 reports/information. The screen 700 for the AR tab will also include a report listing 710 and the KPIs feature 730 (listing the available KPIs for this screen). These functions and reports are the same as the ones discussed above for page 400.

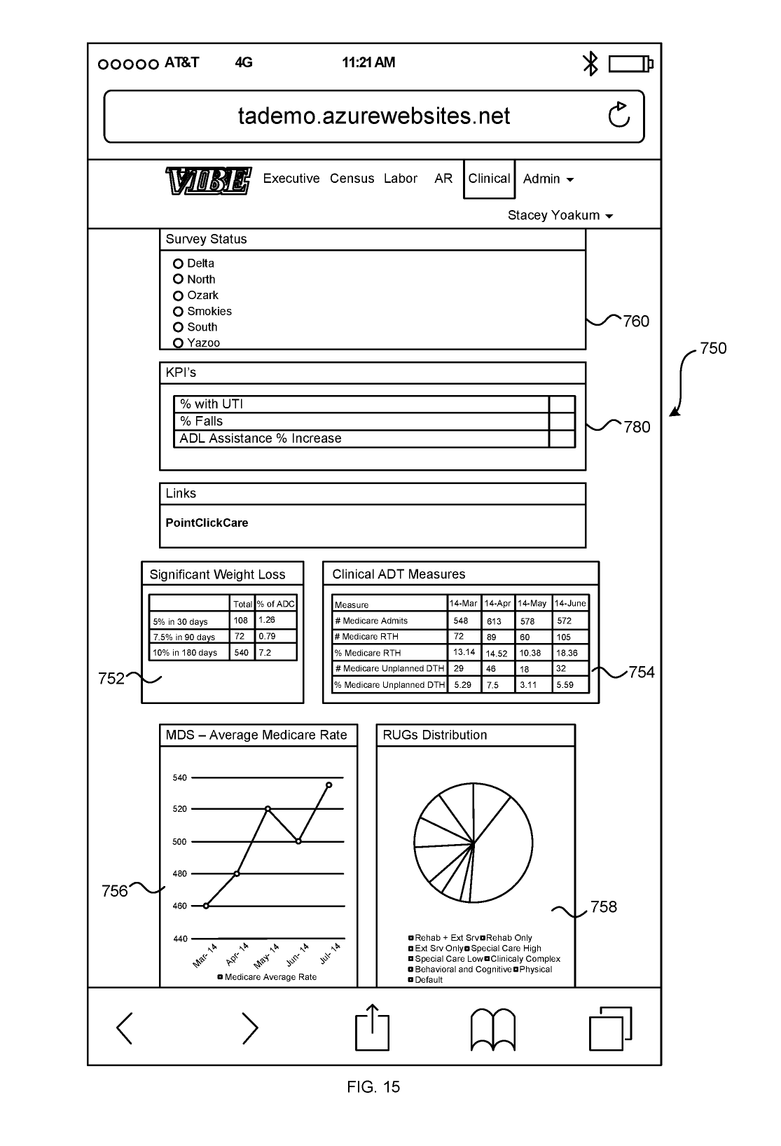

FIG. 15 illustrates an example screen 750 for the clinical tab screen. Like screen 450 discussed above, screen 750 includes graphical and textual illustrations of reports for significant weight loss 752, clinical ADT measures 754, MDS−average Medicare rate 756 and RUGs distribution 758 reports/information. The screen 750 also includes a unique survey status portion 760 and KPI's portion 780. These functions and reports are the same as the ones discussed above for page 450.

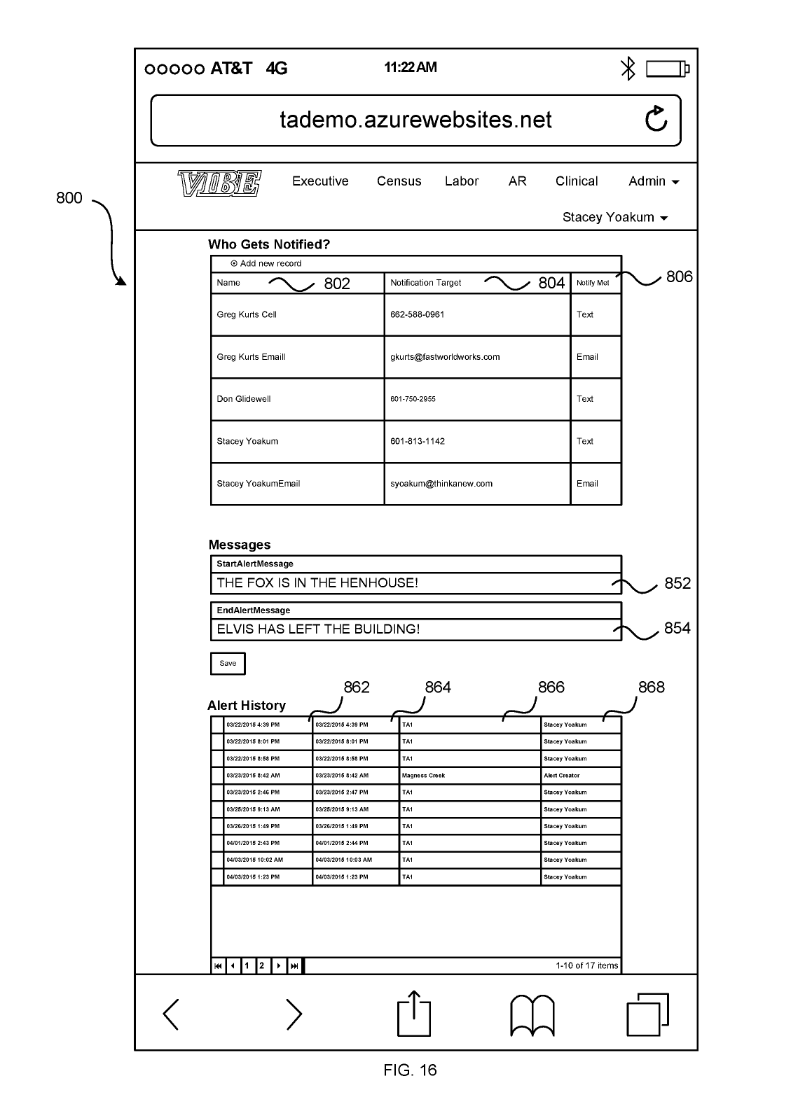

FIG. 16 illustrates an example screen 800 for the admin tab that is similar to the website pages 200, 250 illustrated in FIGS. 4 and 5. That is, screen 800 includes a field 802 for entering the names of the people to receive survey status alerts; a field 804 for a phone number or email address the alert will be sent to; a field 806 for identifying how the alert will be transmitted (e.g., text, email, etc.); and fields (not shown) for editing or deleting the entries on this screen 800. The screen 800 also includes fields for a entering a message 852 for when the visit begins and a message 854 for when the visit is complete. The example screen 800 also displays alert history 860 comprising an alert start date time field 862, alert stop date time field 864, a facility field 866 and an alert creator field 868.

It should be appreciated that the examples set forth herein are provided merely for the purpose of explanation and are in no way to be construed as limiting. While reference to various embodiments is made, the words used herein are words of description and illustration, rather than words of limitation. Further, although reference to particular means, materials, and embodiments are shown, there is no limitation to the particulars disclosed herein. Rather, the embodiments extend to all functionally equivalent structures, methods, and uses, such as are within the scope of the appended claims.

Additionally, the purpose of the Abstract is to enable the patent office and the public generally, and especially the scientists, engineers and practitioners in the art who are not familiar with patent or legal terms or phraseology, to determine quickly from a cursory inspection the nature of the technical disclosure of the application. The Abstract is not intended to be limiting as to the scope of the present inventions in any way.

What is claimed is:

1. A computer implement method of real-time monitoring of key performance indicators, said method comprising:
inputting, at a processor, data associated with a plurality of key performance indicators, said data being input over a network connection;
comparing, at the processor, the data associated with the plurality of key performance indicators to respective thresholds associated with one or more of the plurality of key performance indicators; and
for each of the plurality of key performance indicators having data exceeding the respective threshold, said method comprises:
generating a message or report for the key performance indicator, and
pushing the message or report, via a key performance indicator communication mechanism, to at least one first device capable of receiving and displaying the message or report, said at least one first device being associated with a user associated with the key performance indicator.

2. The method of claim 1, wherein the key performance indicator communication mechanism is a text message and the at least one first device is a mobile device.

3. The method of claim 1, wherein the key performance indicator communication mechanism is an electronic mail message and the at least one first device is one of a computer or mobile device.

4. The method of claim 1, further comprising:
inputting, at the processor, an indication that a survey status alert must be issued;
generating, at the processor, the survey status alert based on pre-stored information input from a storage medium; and
transmitting the survey status alert, via a survey status alert communication mechanism, to at least one second device capable of receiving and displaying the survey status alert, said at least one second device being associated with or more personnel associated with the survey status alert.

5. The method of claim 4, wherein the survey status alert communication mechanism is a text message and the at least one second device is a mobile device.

6. The method of claim 4, wherein the survey status alert communication mechanism is an electronic mail message and the at least one second device is one of a computer or mobile device.

7. The method of claim 1, wherein the key performance indicators are associated with one or more of census, labor, accounts receivable, hospital readmission rates, collection efforts and quality of care.

8. A system for real-time monitoring of key performance indicators, said system comprising:
a computer adapted to:
input data associated with a plurality of key performance indicators, said data being input over a network connection;
compare the data associated with the plurality of key performance indicators to respective thresholds associated with one or more of the plurality of key performance indicators; and
for each of the plurality of key performance indicators having data exceeding the respective threshold:
generate a message or report for the key performance indicator, and
push the message or report, via a key performance indicator communication mechanism, to at least one first device capable of receiving and displaying the message or report, said at least one first device being associated with a user associated with the key performance indicator.

9. The system of claim 8, wherein the key performance indicator communication mechanism is a text message and the at least one first device is a mobile device.

10. The system of claim 8, wherein the key performance indicator communication mechanism is an electronic mail message and the at least one first device is one of a computer or mobile device.

11. The system of claim 8, wherein the computer server is adapted to:
input an indication that a survey status alert must be issued;
generate the survey status alert based on pre-stored information input from a storage medium; and
transmit the survey status alert, via a survey status alert communication mechanism, to at least one second device capable of receiving and displaying the survey status alert, said at least one second device being associated with or more personnel associated with the survey status alert.

12. The system of claim 11, wherein the survey status alert communication mechanism is a text message and the at least one second device is a mobile device.

13. The system of claim 11, wherein the survey status alert communication mechanism is an electronic mail message and the at least one second device is one of a computer or mobile device.

14. The system of claim 8, wherein the key performance indicators are associated with one or more of census, labor, accounts receivable, hospital readmission rates, collection efforts and quality of care.
